(19) United States
(12) Patent Application Publication
(10) Pub. No.: US 2006/0123657 A1
(43) Pub. Date: Jun. 15, 2006

(54) Drying device for powder material

(75) Inventors: Hiroshi Tada, Hirakata-shi (JP); Motoharu Shimizu, Hirakata-shi (JP); Takayuki Okuda, Hirakata-shi (JP); Yorinobu Takino, Hirakata-shi (JP)

Correspondence Address: KODA & ANDROLIA, 2029 CENTURY PARK EAST, SUITE 1140, LOS ANGELES, CA, 90067, US

(73) Assignee: Kabushikaisha Matsui Seisakusho

(21) Appl. No.: 10/532,365

(22) PCT Filed: Oct. 20, 2003
(86) PCT No.: PCT/JP03/13360

§ 371 Date: Sep. 12, 2005

(30) Foreign Application Priority Data
Oct. 21, 2002 (JP) 2002-306360

(51) Int. Cl. F26B 3/00

(52) U.S. Cl. 34/507; 34/443

(57) ABSTRACT

A drying apparatus for powdered or granular material comprising a hopper body with an electric heater in its center, housing therein a heat conducting fin formed with plural compartment walls radially projected therefrom and a carrier gas communication path provided in the conducting fin, which has an upper introduction port and a lower exhaust port, both connected with a penetrating up and down path provided in the center of the heat conducting fin. The apparatus is constructed such that carrier gas externally introduced is fed into the hopper body. According to the apparatus, powdered or granular material is uniformly heated and dried and heating source for carrier gas is not necessary, thereby achieving improvement in energy efficiency and energy saving.

### TECHNICAL FIELD

The present invention relates to an improvement of a drying apparatus for powdered or granular material.

### BACKGROUND ART

The drying apparatus for powdered or granular material according to the prior art is shown in FIG. 6a and FIG. 6b. According to the drying hopper 101 shown in the figure, a tubular heat conducting wall 102 made of a material with high heat conductivity like aluminum is provided at the periphery, an external heating means 103 comprised of a band heater is provided outside of the wall 102, a heat conducting tube 104 made of a material with high heat conductivity like aluminum is provided in the drying hopper 101, and a central heating means 105 comprised of a pipe heater is included at the center.

Plural compartment walls 106 with same thickness are vertically projected out of the heat conducting wall 102 with an even space in a radial manner into the center and plural compartment walls 107 with same thickness are vertically projected out of the heat conducting tube 104 at the center with an even space in a radial manner into the heat conducting wall 102. There are some spaces between the tip ends of opposing these compartment walls 106, 107 so as not to prevent the powdered or granular material from flowing (see Reference 1).

However, small amount and many kinds of resin goods have been produced recently, further the goods have become small. Therefore, the resin molding machine is required to be compact, so that a more compact and simply constructed drying apparatus has been desired in order to meet such demand.

### DISCLOSURE OF THE INVENTION

The present invention has been developed for such demand. The object of the present invention is to provide a drying apparatus for powdered or granular material in which the construction is simple, a powdered or granular material is uniformly dried and energy saving is achieved.

The present invention has been proposed in order to solve the above-mentioned problems. A drying apparatus for powdered or granular material as set forth in claim 1 is comprised of a hopper body with an electric heater in its center, housing therein a heat conducting fin formed with plural compartment walls radially projected therefrom, and a carrier gas communication path provided in the conducting fin, the communication path having an upper introduction port and a lower exhaust port, both connected with a penetrating up and down path provided in the center of the heat conducting fin, wherein a carrier gas is externally introduced and fed into the hopper body.

Such a drying apparatus is preferably used for uniformly dying a small amount of resin molding material. The hoper body is compact and is directly attached to the material supply port of an injection molding machine.

The carrier gas used in the present invention is for example a dehumidified and dried air or an inactive gas. A small amount of carrier gas is fed in the hopper body by means of a compressor, and is heated substantially the same temperature as that of the heat conducting fin when the carrier gas passes through the central path of the heat conducting fin. Thus heated carrier gas uniformly heats and dries a powdered or granular material in addition to the heat conducting from the compartment walls of the fin while the carrier gas moves upward from the bottom of the heat conducting fin in the hopper body.

According to the drying apparatus for powdered or granular material as set forth in claim 2, the hopper body has a material circulation feeder unit, and the feeder unit comprises a material supply means provided under the hopper body, a material collector provided above the hopper body and a material transport pipe connected to the material supply means and the material collector.

According to such a drying apparatus with a material circulation feeder unit, when the material supply operation of the resin material dried in the hopper body into the molding machine is stopped, and the material supply means is operated, the dried material in the hopper body is forcibly brought out to be circulated and returned in the hopper body through the collector, thereby effectively preventing a bridging phenomenon in the hopper body.

According to the drying apparatus for powdered or granular material as set forth in claim 3, the material transport pipe is comprised of a flexible hose detachably connected to the material collector. When the material supply means is operated while the flexible hose is detached, the powdered or granular material stored in the hopper can be discharged from the tip open end of the flexible hose, thereby facilitating material exchange.

According to the drying apparatus for powdered or granular material as set forth in claim 4, the hopper body comprises a tubular container body and a bottom part divisibly combined with the tubular container body with a hinge and a fastening means, and the tubular container body is inclinable relative to the bottom part to open and expose the inner of the bottom part by releasing the fastening means. According to such a construction, cleaning becomes easy, thereby facilitating its maintenance.

### BRIEF DESCRIPTION OF DRAWINGS

FIG. 1 is one embodiment of a drying apparatus for powdered or granular material according to the present invention, FIG. 1a is its vertical sectional view and FIG. 1b is a cross sectional view of a heat conducting fin.

FIG. 2 is an explanatory view in case of cleaning the drying apparatus.

FIG. 3 is a front view when a material circulation feeder unit is incorporated.

FIG. 4 is an explanatory view when a powdered or granular material contained in a hopper body is transported and returned into a material storage tank with a material circulation feeder unit.

FIG. 5 is an explanatory view when a powdered or granular material contained in a hopper body is naturally discharged with the material circulation feeder unit.

FIG. 6 is a drying hopper of a vacuum-type automatic dehumidifying and drying apparatus for powdered or granular material according to the prior art, FIG. 6a is its flat view and FIG. 6b is its vertical sectional view.

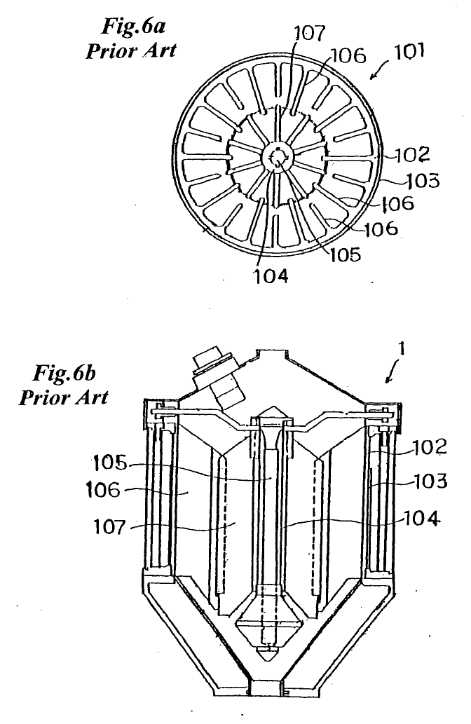

### BEST MODE FOR CARRYING OUT THE INVENTION

The drying apparatus for powdered or granular material is explained referring to the attached drawings.

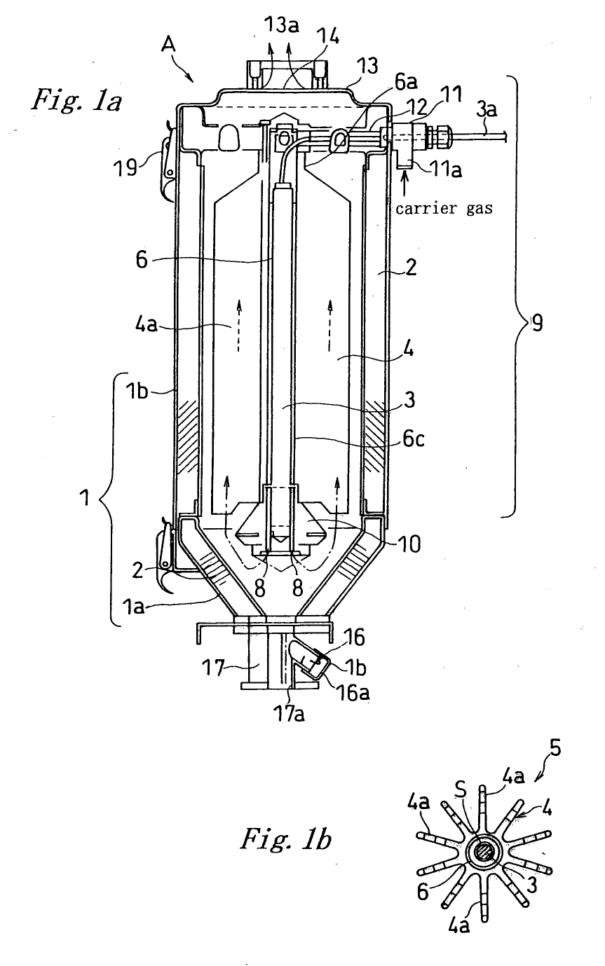

FIG. 1 is one embodiment of a drying apparatus for powdered or granular material according to the present invention, FIG. 1a is its vertical sectional view and FIG. 1b is a cross sectional view of a heat conducting fin.

As shown in FIG. 1a, the drying apparatus A has a tubular insulation material 2 outside of a hopper body 1 and a heat conducting fin 5 radially projecting plural compartment walls 4 hangs to be supported from a cover 13 with a handle 14 at the center in the hopper body 1. The heat conducting fin 5 houses an electric heater 3 and a temperature sensor S in a penetrating path 6 at the center (see FIG. 1b). Carrier gas fed from an introduction port 7 provided at the upper part of the hopper body 1 is communicated in the penetrating path 6 to be exhausted in the hoper body 1 from plural exhaust ports 8 provided for a plug 10, provided at the bottom, into the hopper body 1. The penetrating path 6, the introduction port 7 and the exhaust ports 8 comprise a carrier gas communication path 9. The plug 10 is provided for the first-in and first-out manner of powdered or granular material contained in the hopper body 1 by its gravity.

The introduction port 7 is constructed such that a part of a three-way pipe 11 provided outside of the upper end of the tubular insulation material 2 is opened, the outside end in vertical direction of the three-way pipe 11 is closed, a carrier gas is introduced from the port 11a facing downward and a communication path 12 is formed in horizontal direction into the central penetrating path 6.

The carrier gas is introduced from the introduction port 7, flows in the horizontal path 12, flows down in the central penetrating path 6, and is exhausted from the port 8. Then, the carrier gas flows upward in the hopper body 1 between the plural compartment walls 4 of the heat conducting fin 5 and is exhausted out of the gas exhaust port 14 at the center of the upper cover 13 into atmosphere.

The carrier gas used in the present invention is preferably a dry-processed gas like air or an inactive gas and is pressurized into a predetermined pressure by means of a compressor to be introduced in the hopper body 1.

The carrier gas is introduced into the heat conducting fin 5 at a normal temperature, is heated by the electric heater 3 in the heat conducting fin 5, and is exhausted out of the port 8 provided under the heat conducting fin 5. Thus the powdered or granular material is heated while the carrier gas passes through the hopper body 1. The electric heater 3 is feedback controlled by the temperature sensor S housed in the carrier gas communication path 9, so that the carrier gas is heated into the temperature substantially same as that of the electric heater 3 and the heat conducting fin 5 when it passes through the carrier gas communication path 9. The carrier gas is discharged from the port 8 and uniformly dries the powdered or granular material stored in the hopper 1 while passing upward therethrough. The carrier gas passes upwardly in the hopper body 1 is exhausted from the upper end of the hopper body 1, however, it may be forcibly exhausted by means of a vacuum pump. In such a case, the carrier gas is controlled its passing amount by the vacuum pump, thereby achieving efficient drying process.

Bottom part 1a of the hopper body 1 is formed like a reverse cone, and a material discharge port 16 is projected outwardly from a material supply tube 21 connected under the bottom part 1a, the material discharge port 16 being closed with a cap 16a. When the cap 16a is removed out of the port 16, the powdered or granular material stored in the hopper body 1 is dropped and discharged by the gravity. The numeral 17 indicates a straight pipe which is connected to a material supply port when the drying apparatus A is directly attached on the molding machine (not shown). The powdered or granular material stored in the hopper body 1 falls by its gravity to be supplied to the molding machine through a material feed port 17a of the pipe 17.

According to thus constructed drying apparatus A of the present invention, when the powdered or granular material stored in the hopper body 1 is dried while the temperature in the penetrating path of the heat conducting fin 5 is measured with the temperature sensor S, the carrier gas introduced from outside is heated while passing in the penetrating path 6 in the heat conducting fin 5, the heated carrier gas heats the powdered or granular material in the hopper body 1 in addition to the heating by the heat conducting fin 5 when passing through the powdered or granular material stored in the hopper body 1 from the exhaust port 8, so that the powdered or granular material can be uniformly heated and dried.

Further according to the present invention, the carrier gas is not required to be heated before being introduced in the hopper body 1 and is heated in the hopper body as mentioned above. Therefore, a heating source for carrier gas is not necessary, thereby achieving energy efficiency and energy saving.

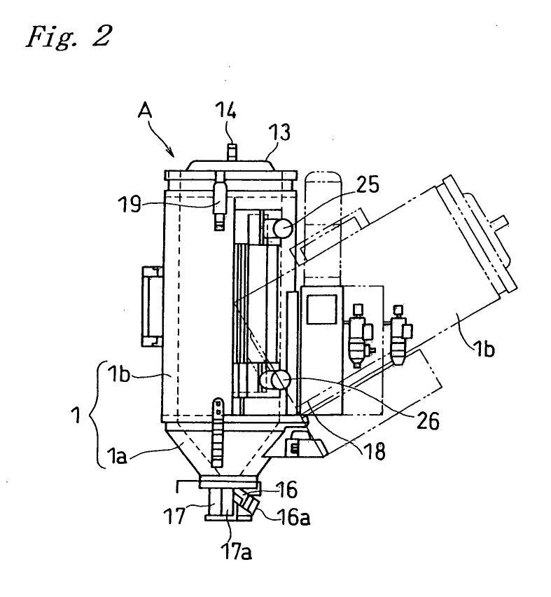

FIG. 2 shows the structural characteristics of the hopper body of the drying apparatus of the present invention.

As shown in the figure, the hopper body 1 is constructed such that the bottom part 1a like a reverse cone provided above the material feed pipe 21 and the tubular container body 1b provided thereon are connected with a hinge 18 and the they are detachable by means of three snap locks 19 provided around the hopper body 1. When the snap locks 19 are released and the tubular container body 1b is inclined as shown with two-dotted lines in the figure, the inside of the bottom part 1a is exposed, thereby facilitating cleaning in the hopper body 1 with cleaning means. After cleaning, the tubular container body 1b is placed on the bottom part 1a and the snap locks 19 are fastened again, the drying apparatus becomes its original shape to prepare a dry process. In this embodiment, the snap lock 19 is used, however, any known fastening means like bolts and nuts may be used.

Next, a material circulation feeder unit which is another characteristic of the drying apparatus of the present invention is explained hereinafter.

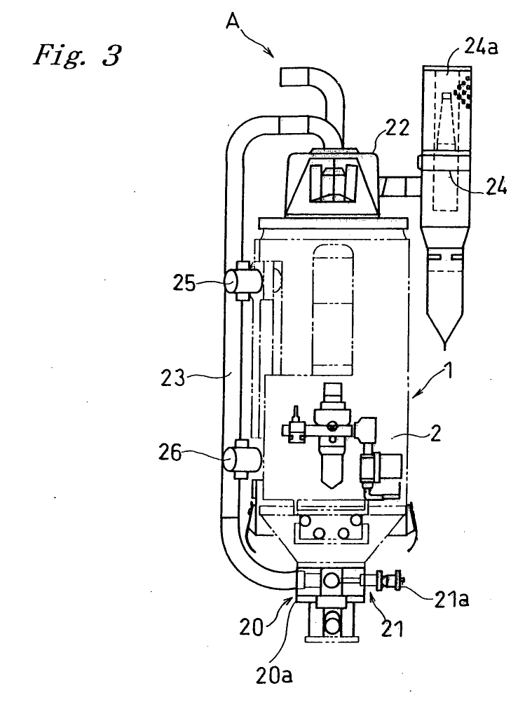

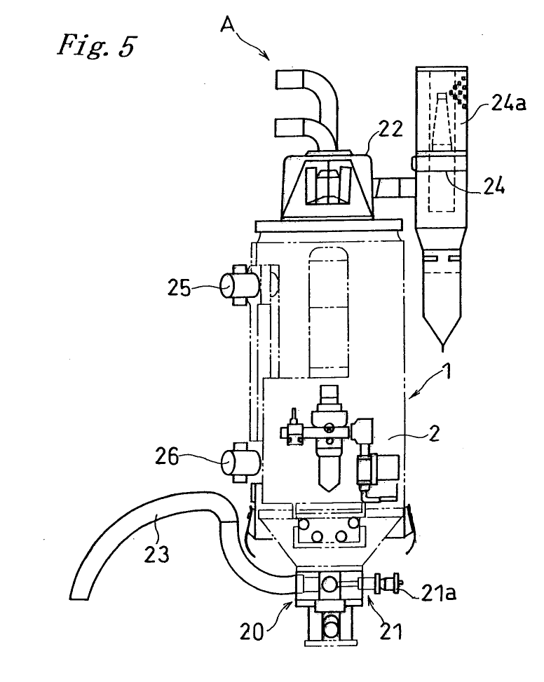

FIG. 3-FIG. 5 show a drying apparatus in which a material circulation feeder unit is provided for the hopper body.

The material circulation feeder unit 20 is constructed such that a material supply means 21 provided under the hopper body 1 and a collector 22 provided above the hopper body 1 are connected with a material transport pipe 23.

The material supply means 21 has an ejector nozzle by which the powdered or granular material stored in the hopper body 1 is forcibly suck and discharged when a pressurized gas introduced from outside is fed.

According to such constructed material circulation feeder unit 20, when the resin material dried in the hopper body 1 is stopped to be fed in the molding machine, the material supply means 21 is operated to forcibly suck the dried material under the hopper body 1 and to circulate and return the material in the hopper body 1 through the collector 22, thereby preventing a bridging phenomenon in the hopper body 1 before happens. One side of the collector 22 is connected to an exhaust pipe 25 having a filter 24, so that the powder or dust are removed by means of the filter 24 and are discharged outside.

The reference numerals 25 and 26 show a level sensor, 25 indicates a sensor for the highest level, and 26 indicates a sensor for the lowest level. If the powdered or granular material supplied in the hopper body 1 to be dried becomes lower than the lowest level sensor 26, the powdered or granular material is supplied from the material supply source through the collector 22 until the material becomes the detection level for the highest sensor 25.

The material circulation feeder unit 20 is preferably constructed such that the material transport pipe 23 is made of a flexible tube and is detachably connected to the material supply means 21 and the connection port 22a of the collector 22.

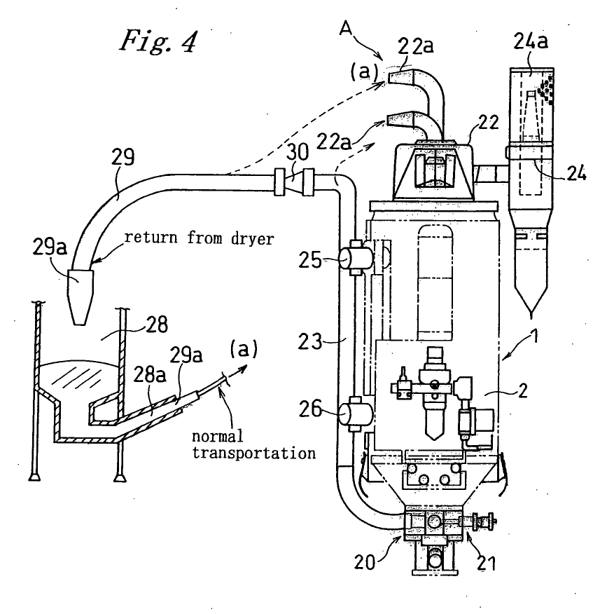

When the material transport pipe 23 is made of a flexible tube, as shown in FIG. 4, the tube is removed from the collector 22, a discharge hose 29 is connected by means of a connector 30, the tip open end 29a is directed to the material storage tank 28, and the material supply means 21 is operated. Then, the powdered or granular material remained in the hopper body 1 is discharged into the material storage tank 28, thereby facilitating exchange of materials.

### INDUSTRIAL APPLICABILITY

A drying apparatus for powdered or granular material is comprised of a hopper body with an electric heater in its center, housing therein a heat conducting fin formed with plural compartment walls radially projected therefrom, and a carrier gas communication path provided in the conducting fin, the communication path having an upper introduction port and a lower exhaust port, both connected with-a penetrating up and down path provided in the center of the heat conducting fin, wherein a carrier gas is externally introduced and fed into the hopper body.

The carrier gas introduced from outside is heated substantially the same temperature as that of the heat conducting fin when the carrier gas passes through the central path of the heat conducting fin. Thus heated carrier gas heats a powdered or granular material and dries it uniformly in addition to the heat conducting from the heat conducting fin while the carrier gas exhausted from the port moves upward from the bottom of the heat conducting fin into the hopper body and passes through the powdered or granular material.

Further, the carrier gas is not required to be heated before being introduced in the hopper body, so that a heating source for carrier gas is not necessary, thereby achieving energy efficiency and energy saving.

Such a drying apparatus is preferably used for uniformly dying a small amount of resin molding material. The hoper body is directly attached to the material supply port of an injection molding machine.

According to the drying apparatus for powdered or granular material of claim 2, when the material supply operation of the resin material dried in the hopper body into the molding machine is stopped through the material supply port of the molding machine and the material supply means of the material circulation feeder unit is operated, the dried material in the hopper body is forcibly brought out to be circulated and returned in the hopper body through the collector, thereby effectively preventing a bridging phenomenon in the hopper body. Still further according to the drying apparatus for powdered or granular material of claim 3 of the present invention, the material transport pipe is comprised of a flexible hose detachably connected to the collector, so that when the flexible hose can be detached from the collector and the material supply means is operated, the powdered or granular material contained in the hopper body is discharged from the open end of the flexible hose.

Furthermore, according to the drying apparatus for powdered or granular material of claim 4 of the present invention, the hopper body is constructed such that a tubular container body is divisibly connected to a bottom part by means of a hinge and a fastening means. In case of cleaning, the tubular container body is inclined by releasing the fastening means and the bottom part is opened so as to be exposed, so that the inside of the hopper body is easily cleaned with a cleaning means, thereby facilitating its maintenance.

1. A drying apparatus for powdered or granular material, comprising:
a hopper body with an electric heater in its center, housing therein a heat conducting fin formed with plural compartment walls radially projected therefrom, and
a carrier gas communication path provided in said conducting fin, said communication path having an upper introduction port and a lower exhaust port, both connected with a penetrating up and down path provided in the center of said heat conducting fin,
wherein a carrier gas is externally introduced and fed into said hopper body.

2. The drying apparatus for powdered or granular material as set forth in claim 1,
wherein said hopper body has a material circulation feeder unit, and wherein said feeder unit comprises a material supply means provided under said hopper body, a material collector provided above said hopper body and a material transport pipe connected to said material supply means and said material collector.

3. The drying apparatus for powdered or granular material as set forth in claim 2, wherein said material transport pipe is comprised of a flexible hose detachably connected to said material collector.

4. The drying apparatus for powdered or granular material as set forth in any one of claims 1-3,
wherein said hopper body comprises a tubular container body and a bottom part divisibly combined with said tubular container body with a hinge and a fastening means, and wherein said tubular container body is inclinable relative to said bottom part to open and expose the inner of said bottom part by releasing said fastening means.
